(19) United States
(12) Patent Application Publication
(10) Pub. No.: US 2016/0088805 A1
(43) Pub. Date: Mar. 31, 2016

(54) Vegetable Tent using a Tomato Cage to protect against Fauna

(71) Applicants: Carl Richard Gyllenhammer, Northborough, MA (US); Kelleen Lynn Loewen, Hudson, MA (US)

(72) Inventors: Carl Richard Gyllenhammer, Northborough, MA (US); Kelleen Lynn Loewen, Hudson, MA (US)

(21) Appl. No.: 14/500,862

(22) Filed: Sep. 29, 2014

(51) Int. Cl. A01G 13/00

(52) U.S. Cl. CPC A01G 13/0243

(57) ABSTRACT

This discloses a device called the vegetable tent. The vegetable tent is made out of various parts that allow for minimal storage space when not in use and can be assembled around a tomato cage (or other support structure) to offer protecting against various fauna, allowing space for the plant to grow and providing easy access to the plant for harvesting.

### FIELD AND BACKGROUND

This invention relates to protective devices for fruit and vegetable plants from damage by various fauna.

### The Problem

One of the problems with growing fruit and vegetables is the damage caused by birds and animals (such as squirrels and the like) to the ripening fruits and vegetables.

### PRIOR ART

The following is a tabulation of some prior art that presently appears relevant:

| Pat. No. | Kind Code | Publication Date | Patentee |
|---|---|---|---|
| 4,395,844 | A | Aug. 2, 1983 | Tom Jopson |
| 4,785,576 | A | Nov. 22, 1988 | Manfred Morgan |
| 4,858,380 | A | Aug. 22, 1989 | Edwin O. Gayle |
| 5,412,905 | A | May 9, 1995 | Ian T. Allison |
| 5,544,446 | A | Aug. 13, 1996 | Donald O. Benson, Jr. |
| 6,360,481 | B1 | Feb. 7, 2001 | Heather Nesic |
| 20070151150 | A1 | Jul. 5, 2007 | Martiniano Sandoval |
| 20070266625 | A1 | Nov. 22, 2007 | Beverly L. Markis |
| 8,308,141 | B1 | Nov. 13, 2012 | Sue M Mellins, Jon |
| | | | Michael Conard |

A standard solution is to place a perimeter fence around the garden area (see U.S. Pat. Nos. 5,544,446, 6,360,481, 20070151150). Others are to create a cage or enclosure around individual plants (see Patent Number 20070266625). But all of these inventions have drawbacks.
(a) Some solutions provide protection against some of the larger fauna, but smaller animals (like squirrels or birds) can easily circumvent them (see U.S. Pat. Nos. 5,412,905, 5,544,446, 6,360,481, 20070151150).
(b) Some solutions require new custom support systems that require a gardener to discard previous investments in standard tomato cages. Increasing costs of the solution (see U.S. Pat. No. 4,395,844).
(c) Some solutions are not easily collapsible, requiring that retail stores that carry the product dedicate shelf space. This means that the product will have to have a higher margin per unit to justify the retail space, thereby increasing retail cost of a solution (see U.S. Pat. No. 4,858,380).
(d) Some solutions block access to the plants, making harvesting more difficult and time consuming (see U.S. Pat. No. 4,785,576).
(e) Some solutions create a hard case for the plants, limiting the plant's growth (see Patent Number 20070266625).

### Summary of the Problems

In summary: Clearly any solution to this problem needs to includes protection, access, cost, and the impact to retail shelf space into the solution.

Thus our devices and methods offer a superior solution as we will demonstrate.

### INVENTION SUMMARY

The invention creates a vegetable tent that can be retrofitted over an existing tomato case (or other vegetable support system).

This vegetable tent system provides the following advantages:
(a) Allows the reuse of any existing tomato cage or support structure.
(b) Offers protection from all fauna including birds and smaller animals including those that can easily climb (such as squirrels)
(c) Easy access to growing fruits and vegetables.
(d) Space around the plant to avoid impeding its growth.

### BRIEF DESCRIPTION OF DRAWINGS

FIG. 1. (100) illustrates one example of a standard type of tomato cage.

FIG. 2. Illustrates the vertical support structure (Assembly 1) that is used to support the vegetable tent. It is made up of the following:

(200) is the end cap with is used to secure the netting (FIG. 4. Assembly 3) to the final vertical support bar (201)

(201) is a vertical support bar. These bars are designed to fit securely into other vertical support bars (201) to allow the height of the center support structure to be varied

(202) is bottom spike cap. This piece is designed to fit into a vertical support bar (201) to allow it to easily penetrate the soil.

FIG. 3. Illustrates the netting support arm (Assembly 2). It is made up of the following:

(300) is a center ring that fits over Assembly 1

(301) are support arms to hold netting out to give space for plant to grow

(302) are support arm end caps that are large enough to insure that the openings in the netting can't slip over (301)

FIG. 4. Illustrates the netting assembly (Assembly 3). It is made up of the following;

(400) A top hole in the netting mesh that can be secured between (200) and (201) on Assembly 1

(401) A flexible mesh netting to allow for compact storage to minimize storage space in retail store

(402) A harvesting access opening that can be secured with zippers, velcor or snaps

FIG. 5. Illustrates an example of a base securing system

(500) base securing rod. A thin tube that is bent in the center that is used to slip through the netting and gets pushed into the ground to anchor the base of the netting

FIG. 6. Illustrates an example of the first embodiment of the invention.

(600) represents connection points that the netting support arms (Assembly 2) are secured to the tomato cage (100)

FIG. 7. Alternate Embodiment of the netting assembly (3a.)

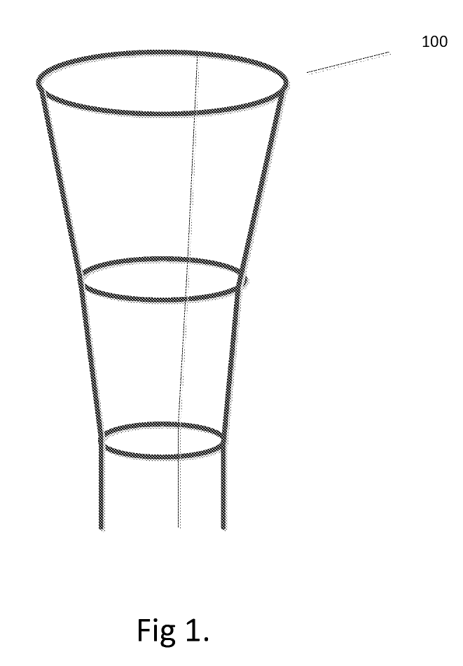

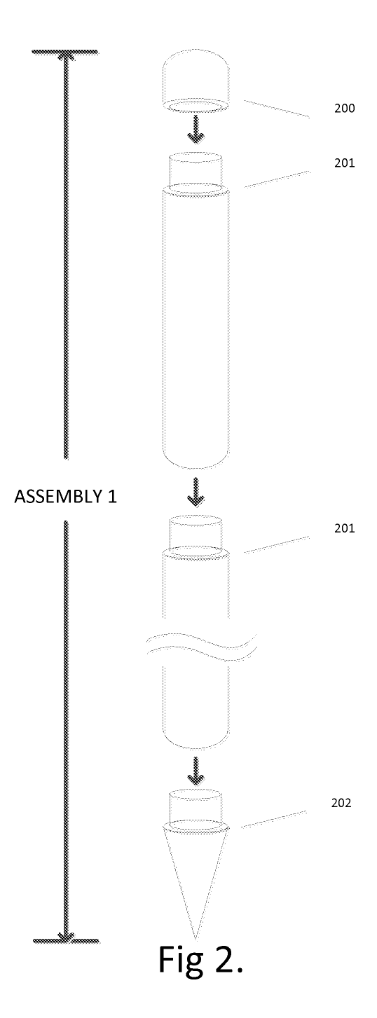

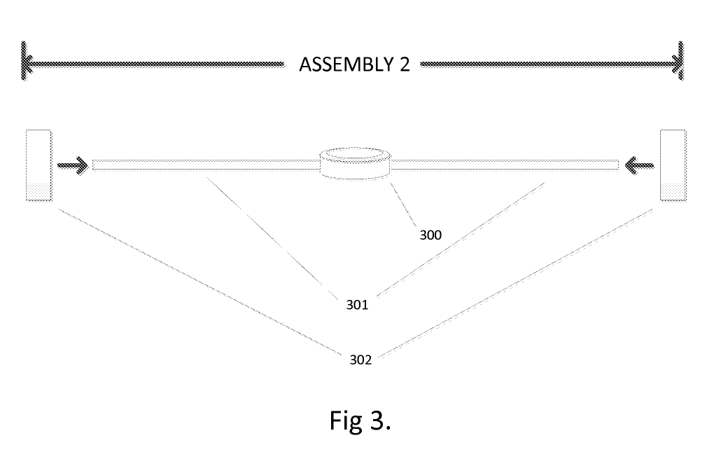

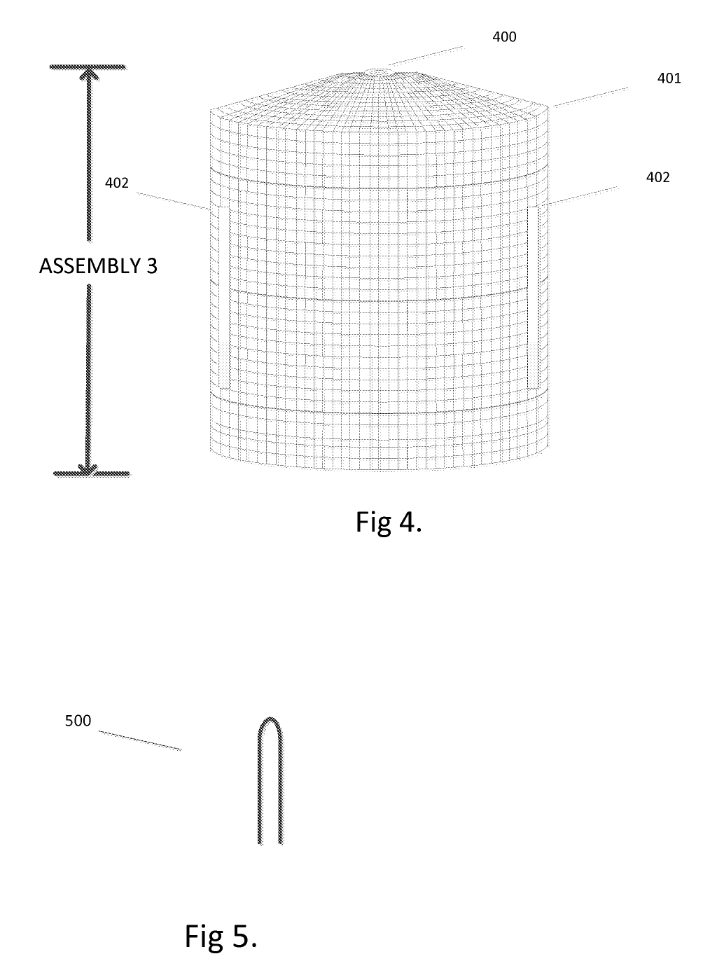

(700) A top hole in the netting mesh that can be secured between (200) and (201) on Assembly 1

(701) A flexible mesh netting to allow for compact storage to minimize storage space in retail store

(702) A harvesting access opening that can be secured with zippers, velcor or snaps

### THE FIRST EMBODIMENT

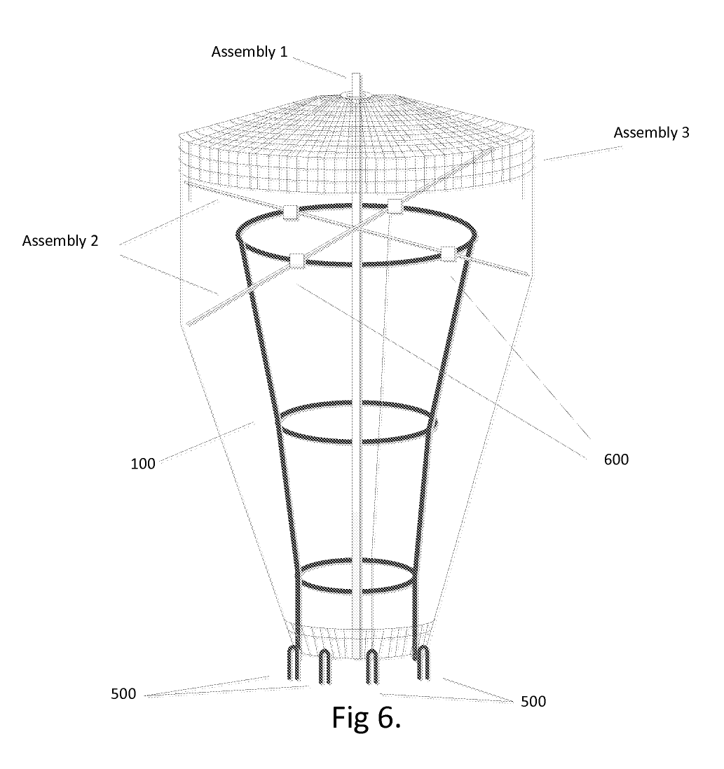

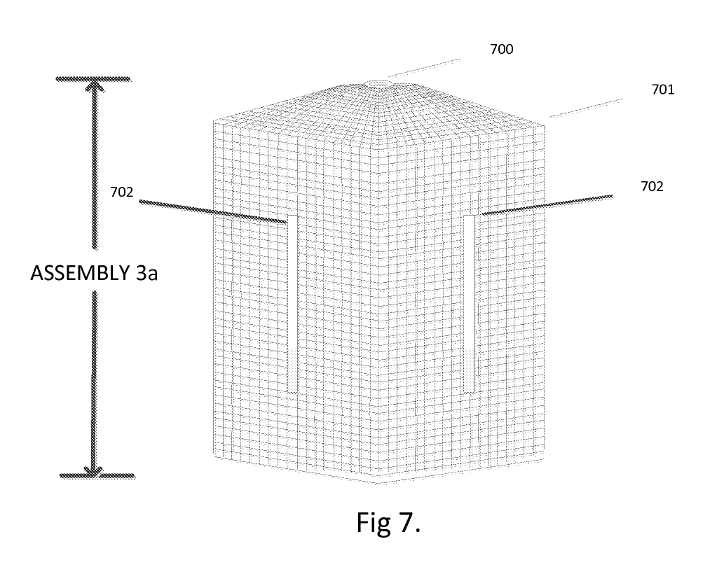

It the first embodiment (FIG. 6.), the
(a) Vertical support structure is partially assembled as follows: The Bottom spike cap (202) would get fitted into the first vertical support bar (201). Other vertical support bars (201) would be added until the desired height is reached. This is then pushed into the ground in the center of the existing tomato cage (100).
(b) Two central support bars (Assembly 1) are then slipped onto the vertical support structure. The two are positioned at right angles to each other and then secured to the top ring (600) of the tomato cage (100) using standard known connection devices like a zip ties or a wire twist tie.
(c) The netting assembly (Assembly 3) is unfolded and slipped over the top vertical support bar (201). This is then locked into place with the end cap (200).
(d) The netting assembly (Assembly 3) is then pulled down to fully encompass the tomato cage with the support arm end caps (302) holding the draped netting away from the tomato cage (100) to allow room for the plant to grow.
(e) The netting assembly (Assembly 3) is pulled down to the ground. A base securing system, in this case base securing rods (500), are then placed periodically through the holes in the netting to anchor the netting assembly to the ground at the base of the tomato cage. This is used to block any access to the plant at the base of the cage
(f) A harvest access opening (402) is located on each side of the netting assembly (Assembly 3) to allow the harvesting of fruits or vegetables without disturbing the vegetable tent setup. The harvest access opening is a slit that can be opened and closed by a known standard device such as a zipper, velcor strip or snaps.

### ALTERNATIVES TO FIRST EMBODIMENT

In some embodiments, the netting assembly (Assembly 3) in a different shape as long as it provides the same function and protection as in the First Embodiment. For example, Assembly 3a shows the netting assembly as a more square shape. The netting assembly can be any shape as long as it offers the same protection as listed in the First Embodiment of the vegetable tent.
In some embodiments, the harvesting access opening (402) in the netting assembly (Assembly 3) as some other re-closable solution other than velroc or a zipper listed in the First Embodiment. For example, buttons or a string ties would also perform the same function. Any solution that offers the same ability to open then netting assembly (Assembly 3) to harvest and then reclose the opening is equivalent.
In some embodiments, the base securing rod (500) of the base securing system is replaced with another method to secure the base of the netting assemble (Assembly 3). For example, a velcor strap, a draw string, rope, a bungie cord. Any solution that offers the ability to seal the base of the netting assembly from fauna is equivalent.
In some embodiments, the round tomato cage (100) is replaced with an equivalent support structure. For example, a square tomato cage or a wood frame. Any solution that offers the support for a vegetable tent is equivalent.

### Advantages

This approach has several advantages over the current art.

First, since all the parts come in smaller pieces and the netting is foldable, it can be fit into a small physical space to minimize store shelf space and also minimize any storage space needed in between growing seasons.

Second, once the protective cage is securely set up, access to the fruit or vegetables inside the netting can be done without disturbing the structure

Third, the vegetable tent can reuse any existing tomato cage or support structure which lowers the cost of the solution.

Forth, the invention can keep out all fauna larger than the netting spacing size.

Fifth, the invention allows the plant to grown without being restricted by the protective netting.

### CONCLUSIONS, RAMIFICATIONS AND SCOPE

One skilled in the art will see that the advantages of the described invention are many, and that the embodiments shown are not limiting but rather representative of many configurations this invention.

Due to the reasons list above, the vegetable tent is a superior solution to the problem and we expect it to generate substantial sales.

We claim:

1. A device, called a vegetable tent:
(a) comprising a vertical support assembly, a netting support arm assembly, a netting assembly, and a base securing system;
where:
(b) said netting assembly comprises a plurality of nets;
(c) said netting support arm assembly comprises a set of rods, called support rods, connected to each other, and when deployed said support rods are parallel to the ground;
(d) said vertical support assembly comprises a set of rods, called vertical rods, connected to each other, and when deployed said vertical rods are perpendicular to the ground;
(e) said base securing system comprises a set of rods, called securing rods, and when deployed said securing rods are secured into the ground;
(f) when said vegetable tent is deployed:
i> said netting assembly is secured to said vertical support assembly;
ii> said netting assembly rests on or is secured by said netting support arm assembly;
iii> said vertical support assembly is secured by the netting support arm assembly;
iv> said vertical support assembly is secured at its base to the ground; and
v> said base securing system secures said netting assembly to the ground;
(g) said vegetable tent is adapted for easy manual separation into its component parts for storage;
(h) said netting assembly comprises nets with a mesh of connected nets whose maximum diameter does not exceed 0.5 inches, thereby providing a protective barrier for plants inside it while allowing water, air and sunlight to pass through, to any plants said netting assembly protects;
(i) said vegetable tent being adapted to placement over an existing tomato cage; thereby when deployed preventing fauna from eating vegetables growing inside said vegetable cage while still allowing the plants inside said vegetable cage to access light, air, water, and the ground which is found in the surrounding environment.

2. The vegetable cage of claim 1 having a gap of 0.1 to 6 inches from the end of the top ring of said tomato cage and the end of said netting support arm assembly; there providing space between said netting assembly and said tomato cage to allow plants to grow.

3. The vegetable cage of claim 1 having said base securing system anchored to the ground around said tomato cage; thereby blocking fauna access to any enclosed plants at ground level.
